(19) United States
(12) Patent Application Publication
(10) Pub. No.: US 2024/0116238 A1
(43) Pub. Date: Apr. 11, 2024

(54) LENGTH ORIENTATION SYSTEM AND METHOD FOR ACHIEVING HIGH STRETCH RATIO UNIFORMITY

(71) Applicant: Meta Platforms Technologies, LLC, Menlo Park, CA (US)

(72) Inventors: Andrew John Ouderkirk, Kirkland, WA (US); Nagi Hosni Elabbasi, Southborough, MA (US); Sheng Ye, Redmond, WA (US); Arman Boromand, Issaquah, WA (US); Jing Chen, Redmond, WA (US)

(21) Appl. No.: 18/191,369

(22) Filed: Mar. 28, 2023

Related U.S. Application Data
(60) Provisional application No. 63/414,740, filed on Oct. 10, 2022.

(51) Int. Cl. B29C 55/08

(52) U.S. Cl. CPC B29C 55/08; B29K 2995/0041; B29K 2995/0051

(57) ABSTRACT

A method of forming a uniaxially oriented crystalline polymer article includes heating a segment of a crystallizable polymer article to a first temperature, applying a stress to the crystallizable polymer article in an amount effective to induce a positive strain within the segment of the crystallizable polymer article, and heating the segment of the crystallizable polymer article to a second temperature greater than the first temperature while continuing to apply the stress.

### CROSS-REFERENCE TO RELATED APPLICATION

This application claims the benefit of priority under 35 U.S.C. § 119(e) of U.S. Provisional Application No. 63/414,740, filed Oct. 10, 2022, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a schematic view of an example thin film orientation system for manufacturing an oriented crystalline polymer thin film according to some embodiments.

FIG. 2 is a schematic view of a thin film orientation system for manufacturing an oriented crystalline polymer thin film according to further embodiments.

FIG. 3 illustrates a roll-to-roll manufacturing configuration for conveying and orienting a polymer thin film according to certain embodiments.

FIG. 4 is a schematic illustration of an example length orientation system for forming an oriented polymer thin film according to some embodiments.

FIG. 5 shows a strain map of a polymer thin film following orientation using the length orientation system of FIG. 4 according to certain embodiments.

FIG. 6 is a schematic illustration of a further example length orientation system for forming an oriented polymer thin film according to some embodiments.

FIG. 7 shows a strain map of a polymer thin film following orientation using the length orientation system of FIG. 6 according to certain embodiments.

FIG. 8 is a schematic illustration of a length orientation system having an array of IR heating elements located within heating and stretching zones according to some embodiments.

FIG. 9 is a schematic illustration of a length orientation system having an array of forced fluid heating elements located within heating and stretching zones according to various embodiments.

FIG. 10 is a schematic illustration of a length orientation system having opposing arrays of forced fluid heating elements located within heating and stretching zones according to some embodiments.

FIG. 11 is a schematic illustration of a length orientation system having opposing hybrid arrays of heating elements located within heating and stretching zones according to some embodiments.

FIG. 12 is a modeled deformation map showing the stretching of a polymer thin film while undergoing differential heating between feeder and take-up rollers of a length orientation system according to various embodiments.

FIG. 13 illustrates an aspect of the finite modeling of differential heating of a polymer thin film stretched between feeder and take-up rollers of a length orientation system according to some embodiments.

FIG. 14 shows a modeled comparison of achievable stretch ratio uniformities for length orientation systems having relatively narrow and relatively wide heating zones according to certain embodiments.

FIG. 15 shows a modeled comparison of achievable stretch ratio uniformities for length orientation systems having relatively narrow and relatively wide heating zones according to further embodiments.

FIG. 16 illustrates the modeled stretch ratio uniformity accompanying a 4.2× stretch for a length orientation system having a medium width heating zone according to some embodiments.

FIG. 17 illustrates the modeled stretch ratio uniformity accompanying a 3.8× stretch for a length orientation system having a wide heating zone according to some embodiments.

FIG. 18 shows the modeled stretch ratio uniformity accompanying a 5.4× stretch for a length orientation system having a wide heating zone according to further embodiments.

FIG. 19 shows the temperature profile and a corresponding stress profile along a length orientation direction of a length orientation system according to some embodiments.

FIG. 20 illustrates the effect of temperature uniformity within a length orientation system on the orientation profile of polymer chains in stretched polymer thin films according to some embodiments.

FIG. 21 is an illustration of exemplary augmented-reality glasses that may be used in connection with embodiments of this disclosure.

FIG. 22 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Polymer materials may be incorporated into a variety of different optic and electro-optic systems, including passive and active optics and electroactive devices. Lightweight and conformable, one or more polymer layers may be incorporated into wearable devices such as smart glasses and are attractive candidates for emerging technologies including virtual reality/augmented reality devices where a comfortable, adjustable form factor is desired.

Virtual reality (VR) and augmented reality (AR) eyewear devices and headsets, for instance, may enable users to experience events, such as interactions with people in a computer-generated simulation of a three-dimensional world or viewing data superimposed on a real-world view. By way of example, superimposing information onto a field of view may be achieved through an optical head-mounted display (OHMD) or by using embedded wireless glasses with a transparent heads-up display (HUD) or augmented reality (AR) overlay.

VR/AR eyewear devices and headsets may be used for a variety of purposes. Governments may use such devices for military training, medical professionals may use such devices to simulate surgery, and engineers may use such devices as design visualization aids. These and other applications may leverage one or more characteristics of polymer materials, including the refractive index to manipulate light, thermal conductivity to manage heat, and mechanical strength and toughness to provide light-weight structural support.

According to some embodiments, suitably oriented piezoelectric polymer thin films, for instance, may be implemented as an actuatable lens substrate in an optical element such as a liquid lens. Uniaxially-oriented polyvinylidene fluoride (PVDF) thin films, for example, may be used to generate an advantageously anisotropic strain map across the field of view of a lens. However, comparative manufacturing paradigms for generating oriented polymer thin films, including uniaxially oriented thin films and sequentially biaxially oriented thin films, may create a variable orientation ratio across one or more dimensions of the thin film and attendant non-uniformity in one or more properties (e.g., optical, mechanical, thermal, and electro-optic properties, and the like), which may adversely affect yield, product performance, and cost.

Notwithstanding recent developments, it would be advantageous to provide strain-hardened polymer articles having spatially uniform optical, mechanical, and/or thermal properties. For example, polymer thin films having directionally uniform in-plane properties may be incorporated into various optical systems including display systems for artificial reality applications. The instant disclosure is thus directed generally to the manufacture of structurally and compositionally uniform polymer materials, and more specifically to the manufacture of uniaxially-oriented crystalline polymer thin films and fibers using methods that include stretching and orienting in a thermally dynamic environment.

An oriented crystalline polymer thin film or fiber may be formed by applying a desired stress state to a crystallizable polymer. For instance, a polymer composition capable of crystallizing may be formed into a fiber or a single layer using appropriate extrusion or casting operations. For example, a vinylidene fluoride-containing composition may be extruded and oriented as a single layer to form a mechanically and piezoelectrically anisotropic thin film. According to further embodiments, a crystallizable polymer may be co-extruded with other polymer materials that are either crystallizable, or those that remain amorphous after orientation, to form a multilayer thin film.

In accordance with various embodiments, a method of forming a uniaxially oriented crystalline polymer article includes heating a segment of a crystallizable polymer article to a first temperature, applying a stress to the crystallizable polymer article in an amount effective to induce a positive strain within the heated segment, and heating the segment of the crystallizable polymer article to a second temperature greater than the first temperature while continuing to apply the stress. As will be appreciated, heating and stretching of the crystallizable polymer article may include a continuous temperature change between the first and second temperatures. Alternatively, the act of heating may include pausing the increase in the temperature at one or more dwell temperatures between the first temperature and the second temperature while applying the stress.

The application of a uniaxial or biaxial stress to an extruded or cast single or multilayer thin film may be used to align polymer chains and/or orient crystals to induce optical and mechanical anisotropy. Such thin films may be used to fabricate anisotropic piezoelectric substrates, birefringent substrates, high Poisson's ratio thin films, reflective polarizers, birefringent mirrors, and the like, and may be incorporated into AR/VR combiners or used to provide display brightness enhancement.

As used herein, the terms “polymer thin film” and “polymer layer” may be used interchangeably. Furthermore, reference to a “polymer thin film” or a “polymer layer” may include reference to a “multilayer polymer thin film” and the like, unless the context clearly indicates otherwise.

In accordance with various embodiments, example crystallizable polymers include fluoropolymers, such as polytetrafluoroethylene (PTFE) and “PVDF-family” moieties such as vinylidene fluoride (VDF), trifluoroethylene (TrFE), chlorotrifluoroethylene (CTFE), hexafluoropropylene (HFP), and vinyl fluoride (VF), as well as homopolymers, co-polymers, tri-polymers, derivatives, and combinations thereof.

Further example crystallizable polymers include polyethylene and various polyesters. Example polyethylene materials include high molecular weight polyethylene, high density polyethylene (HDPE), linear low density polyethylene (LLDPE), ultrahigh molecular weight polyethylene (UHMWPE), as well as derivatives and mixtures thereof. Example polyesters include polyethylene terephthalate (PET), polyethylene isophthalate, polyethylene terephthalate glycol (PETG), poly(ethylene 2,6-naphthalate), poly(ethylene 1,4-naphthalate), polybutylene terephthalate (PBT), and their co-polymers.

Additional crystallizable polyesters include polypropylene (e.g., isotactic polypropylene and syndiotactic polypropylene), polyamides, polyarylamides (e.g., polyphthalamide and aromatic polyamides), polyoxymethylene, polyether ether ketone, polyaryl ether ketone, polyether ketone, polyether ketone ketone, liquid crystal polymers, polyvinylidene chloride, polyphenylene sulfide, polyimide and poly(lactic acid), although further compositions are contemplated.

According to some embodiments, a crystallizable polymer may have a monomodal molecular weight distribution (i.e., “high molecular weight”) of at least approximately 100,000 g/mol, e.g., at least 100,000 g/mol, at least 150,000 g/mol, at least 200,000 g/mol, at least 250,000 g/mol, at least 300,000 g/mol, at least 350,000 g/mol, at least 400,000 g/mol, at least 450,000 g/mol, or at least 500,000 g/mol, including ranges between any of the foregoing values. According to further embodiments, the crystallizable polymer may have a bimodal molecular weight distribution that includes a high molecular weight component and a “low molecular weight” component having a molecular weight of less than approximately 200,000 g/mol, e.g., less than 200,000 g/mol, less than 100,000 g/mol, less than 50,000 g/mol, less than 10,000 g/mol, less than 7,500 g/mol, less than 5,000 g/mol, less than 2,500 g/mol, less than 2,000 g/mol, or less than 1,000 g/mol, including ranges between any of the foregoing values. Use herein of the term “molecular weight” may, in some examples, refer to a weight average molecular weight.

Example methods of forming a uniaxially-oriented crystalline polymer thin film or fiber may include extrusion or casting processes to create a desired form factor, and subsequent stretching to align crystallites and/or polymer chains along a predetermined direction. For instance, a polymer thin film may be formed by solvent casting from a polymer solution. A polymer solution may include one or more crystallizable polymers and one or more liquid solvents. Solvent casting, which may provide control of one or more of the polymer composition and concentration, choice and concentration of liquid solvent, and casting temperature, for example, may facilitate decreased entanglement of polymer chains and allow the polymer film to achieve a higher stretch ratio during a later deformation step. A polymer film may be obtained from the polymer solution by evaporating the solvent. The polymer film may be transparent, translucent, or opaque.

The choice of liquid solvent may affect the crystalline phase and crystalline content of a polymer thin film or fiber. In addition, the polarity of the solvent may impact the critical polymer concentration (c*) for polymer chains to entangle in solution. The liquid solvent (i.e., “solvent”) may include a single solvent composition or a mixture of different solvents. In some embodiments, the solubility of the crystallizable polymer in the liquid solvent may be at least approximately 0.1 g/100 g (e.g., 1 g/100 g or 10 g/100 g) at a temperature of 25° C. or more (e.g., 50° C., 75° C., 100° C., or 150° C.).

Example liquid solvents include, but are not limited to, dimethylformamide (DMF), cyclohexanone, dimethylacetamide (DMAc), diacetone alcohol, di-isobutyl ketone, tetramethyl urea, ethyl acetoacetate, dimethyl sulfoxide (DMSO), trimethyl phosphate, N-methyl-2-pyrrolidone (NMP), butyrolactone, isophorone, triethyl phosphate, carbitol acetate, propylene carbonate, glyceryl triacetate, dimethyl phthalate, acetone, tetrahydrofuran (THF), methyl ethyl ketone, methyl isobutyl ketone, glycol ethers, glycol ether esters, and N-butyl acetate.

In some cases, a polymer gel may be obtained from the polymer solution by evaporating the solvent, cooling the polymer solution, adding a relatively poor solvent to the polymer solution, or a combination thereof. The solubility of the crystalline polymer in a poor solvent may be less than 20 g/100 g, e.g., 5 g/100 g or 1 g/100 g at a temperature of less than approximately 150° C., e.g., 75° C., 25° C., 0° C., −40° C., or −70° C. The polymer gel, which includes a mixture of the crystallizable polymer and the liquid solvent, may be transparent, translucent, or opaque.

A polymer thin film can be oriented either uniaxially or biaxially as a single layer or multilayer to form an anisotropic crystalline polymer thin film. An anisotropic polymer thin film may be formed using a thin film orientation system configured to heat and stretch a polymer thin film in at least one in-plane direction in one or more distinct regions thereof. In some embodiments, a thin film orientation system may be configured to stretch a polymer thin film, i.e., a crystallizable polymer-containing thin film, along only one in-plane direction. For instance, a thin film orientation system may be configured to apply an in-plane stress to a polymer thin film along the x-direction while allowing the thin film to relax along an orthogonal in-plane direction (i.e., along the y-direction). As used herein, the relaxation of a polymer thin film may, in certain examples, accompany the absence of an applied stress along a relaxation direction.

According to some embodiments, within an example system, a polymer thin film may be heated and stretched transversely to a direction of film travel through the system. In such embodiments, a polymer thin film may be held along opposing edges by plural movable clips slidably disposed along a diverging track system such that the polymer thin film is stretched in a transverse direction (TD) as it moves along a machine direction (MD) through heating and deformation zones of the thin film orientation system. The clips may be configured to slide along a parabolic path, for example. In some embodiments, the stretching rate in the transverse direction and the relaxation rate in the machine direction may be independently and locally controlled. In certain embodiments, large scale production may be enabled, for example, using a roll-to-roll manufacturing platform.

In certain aspects, the tensile stress may be applied uniformly or non-uniformly along a lengthwise or widthwise dimension of the polymer thin film. Heating of the polymer thin film may accompany the application of the tensile stress. For instance, a semi-crystalline polymer thin film may be heated to a temperature greater than room temperature (˜23° C.) to facilitate deformation of the thin film and the formation and realignment of crystals and/or polymer chains therein.

The temperature of the polymer thin film may be maintained at a desired value or within a desired range before, during and/or after the act of stretching, i.e., within a pre-heating zone or a deformation zone downstream of the pre-heating zone, in order to improve the deformability of the polymer thin film relative to an un-heated polymer thin film. The temperature of the polymer thin film within a deformation zone may be less than, equal to, or greater than the temperature of the polymer thin film within a pre-heating zone. The temperature within a deformation zone may be greater than approximately 60° C., i.e., greater than 80° C., greater than 100° C., greater than 120° C., greater than 140° C., greater than 160° C., or greater than 180° C., including ranges between any of the foregoing values.

In some embodiments, the polymer thin film may be heated to a constant temperature throughout the act of stretching. In some embodiments, a region of the polymer thin film may be heated to different temperatures, i.e., during and/or subsequent to the application of the tensile stress. In particular examples, during the act of stretching, the temperature of the polymer thin film may be increased, e.g., continuously or discontinuously, such as in a step-wise fashion. In some embodiments, different regions of the polymer thin film may be heated to different temperatures. In certain embodiments, the strain realized in response to the applied tensile stress may be at least approximately 20%, e.g., approximately 20%, approximately 50%, approximately 100%, approximately 200%, approximately 400%, approximately 500%, approximately 750%, approximately 1000%, approximately 2000%, or more, including ranges between any of the foregoing values.

As will be appreciated, a polymer article may undergo strain hardening during the act of stretching. Strain hardening may be observed as a strengthening of the material during large strain deformation, and may be caused by large scale reorientation of chain molecules and lamellar crystals. According to some embodiments, the temperature of the polymer article may be increased during the act of stretching by an amount effective to maintain adequate deformability to allow further crystal and/or polymer chain realignment throughout the act of stretching.

In some embodiments, the crystalline content within the polymer thin film may increase during the act of stretching. In some embodiments, stretching may alter the orientation of crystals within a polymer thin film without substantially changing the crystalline content. In accordance with various embodiments, a “crystalline polymer” thin film may include at least approximately 50% crystalline content, e.g., 50, 60, 70, 80, 90, 95, 97, 98, 99, or 100% crystalline content, including ranges between any of the foregoing values.

Following deformation and orientation of a polymer thin film, the heating may be maintained for a predetermined amount of time, followed by cooling. The act of cooling may include allowing the polymer material to cool naturally, at a set cooling rate, or by quenching, such as by purging with a low temperature gas, which may thermally stabilize the polymer thin film.

By way of example, stretching a PVDF-family polymer thin film may form both alfa and beta phase crystals, although only aligned beta phase crystals contribute to piezoelectric response. During and/or after a stretching process, an electric field may be applied to the polymer thin film. For instance, the electric field may be applied across the film's thickness dimension. The application of an electric field (i.e., poling) may induce the formation and alignment of beta phase crystals. Whereas a lower electric field can be applied to align beta phase crystals, a higher electric field can be applied to both induce a phase transformation from the alpha phase to the beta phase and encourage alignment of the beta phase crystals. High piezoelectric performance may be associated with the creation and alignment of beta phase crystals in PVDF-family polymers. Example poling times may range from approximately 1 min to approximately 180 min. During poling, a PVDF thin film may be heated to a temperature of from approximately 20° C. to approximately 5° C. below the Curie temperature of the polymer.

In example methods, a polymer thin film may be heated during stretching to a temperature of from approximately 60° C. to approximately 190° C. and stretched at a strain rate of from approximately 0.1%/sec to 300%/sec. Moreover, one or both of the temperature and the strain rate may be held constant or varied during the act of stretching. For instance, a polymer thin film may be stretched at a first temperature and a first strain rate (e.g., 130° C. and 50%/sec) to achieve a first stretch ratio. Subsequently, the temperature of the polymer thin film may be increased, and the strain rate may be decreased, to a second temperature and a second strain rate (e.g., 165° C. and 5%/sec) to achieve a second stretch ratio. Uniformity of the stretch ratio may be improved by increasing the temperature of the polymer thin film throughout the act of stretching.

In some embodiments, following stretching, a polymer thin film may be annealed. Annealing may be performed at a fixed or variable stretch ratio. Annealing may be performed at constant or variable stress or at constant or variable strain. An example annealing temperature may be greater than approximately 60° C., e.g., 80° C., 100° C., 120° C., 130° C., 140° C., 150° C., 160° C., 170° C., 180° C., or 190° C., including ranges between any of the foregoing values. The annealing temperature may be constant or may be variable (e.g., increasing) throughout an annealing step. The annealing process may include a single annealing step (e.g., a single temperature) or multiple steps (e.g., at multiple temperatures). Without wishing to be bound by theory, annealing may stabilize the orientation of polymer chains and decrease the propensity for shrinkage of a polymer thin film.

Following deformation, the crystals or chains may be at least partially aligned with the direction of the applied tensile stress. As such, a polymer thin film may exhibit a high degree of birefringence, a high degree of optical clarity, transmissivity within or across the optical spectrum of at least approximately 50%, bulk haze of less than approximately 10%, a high piezoelectric strain coefficient, e.g., d₃₁ greater than approximately 10 pC/N and/or a high electromechanical coupling coefficient, e.g., k₃₁ greater than approximately 0.15.

According to further embodiments, a method of forming a polymer fiber may include gel spinning. Gel spinning refers to a technique where a polymer gel is extruded through a spinneret nozzle to form a polymer fiber. In an example method, a solvent bath located downstream of the spinneret nozzle and containing a poor solvent may be used to precipitate the fiber. Exemplary dispense rates of the polymer gel through the nozzle, which may be determined based on the rheological properties of the gel, may range from approximately 0.1 to 10 mL/hr. Suitable poor solvents for PVDF may include THF, cyclohexanone, acetone, and the like. The solvent temperature within the solvent bath may be less than approximately 50° C., e.g., less than 50° C., less than 40° C., less than 30° C., less than 20° C., or less than 10° C., including ranges between any of the foregoing values.

In an electro-spinning method, a polymer gel may be dispensed through a spinneret nozzle. Example dispense rates may range from approximately 0.1 to 10 mL/hr. During electro-spinning, a first voltage may be applied to the spinneret nozzle and an opposite voltage may be applied to a collection roller located proximate to the nozzle. The magnitude of the voltages may be independently set. An absolute value of the applied voltages may range from approximately 5 to approximately 100 kV.

According to various embodiments, an additional method of forming a polymer fiber may include melt spinning. Melt spinning refers to a technique where a polymer melt is extruded through a spinneret nozzle to form the fiber. The spun fibers may be cooled and collected. Exemplary dispense rates of the polymer melt through the nozzle, which may be determined based on the rheological properties of the gel, may range from approximately 0.1 to 10 mL/hr.

In some examples, a spun polymer fiber may be stretched under a constant stress of at least approximately 100 MPa, e.g., 100, 150, 200, 250, or 300 MPa, including ranges between any of the foregoing values. A polymer fiber may be stretched along an axial direction, for example. In some examples, a fiber stretch ratio may be greater than approximately 8, e.g., 8, 10, 15, 20, 30, or more, where a strain rate may range from approximately 0.1%/sec to approximately 300%/sec. The act of stretching may include a single stretching step or plural (i.e., successive) stretching steps where one or more of a stretching temperature and a strain rate may be independently controlled.

In some embodiments, the crystalline content within the polymer fiber may increase during the act of stretching. In some embodiments, stretching may alter the orientation of crystals within a polymer fiber without substantially changing the crystalline content.

Polymer fibers may be annealed during and/or after orientation. Annealing may be performed at a fixed or variable stretch ratio and/or a fixed or variable applied stress. In some embodiments, a polymer fiber may be annealed while under an applied real stress of at least approximately 100 MPa, e.g., 100, 150, 200, 250, or 300 MPa, including ranges between any of the foregoing values. An annealing temperature may be fixed or variable. A variable annealing temperature, for instance, may increase from an initial annealing temperature to a final annealing temperature. The annealing temperature may be greater than the polymer's glass transition temperature (T g) and, in certain examples, may be less than, substantially equal to, or greater than the temperature corresponding to the onset of melting for the polymer.

An example annealing temperature may be greater than approximately 80° C., e.g., 100° C., 120° C., 140° C., 160° C., or 180° C., including ranges between any of the foregoing values. In embodiments where annealing accompanies orienting, one or both of the temperature and the strain rate may be held constant or varied. For instance, a polymer fiber may be stretched at a first temperature and a first strain rate (e.g., 130° C. and 50%/sec) to achieve a first stretch ratio. Subsequently, the temperature of the polymer fiber may be increased, and the strain rate may be decreased to a second temperature and a second strain rate (e.g., 165° C. and 5%/sec) to achieve a second stretch ratio. Annealing may stabilize the orientation of polymer chains and decrease the propensity for shrinkage of the polymer fiber.

Following orienting of the polymer fiber, the heating may be maintained for a predetermined amount of time, followed by cooling of the fiber. The act of cooling may include allowing the polymer fiber to cool naturally, at a set cooling rate, or by quenching, such as by purging with a low temperature gas, which may thermally stabilize the polymer fiber.

By way of example, stretching a PVDF-family fiber may form both alpha and beta phase crystals, although only aligned beta phase crystals contribute to piezoelectric response. During and/or after a stretching process, an electric field may be applied to the polymer fiber. The application of an electric field (i.e., poling) may induce the formation and alignment of beta phase crystals. Whereas a lower electric field may be applied to align beta phase crystals, a higher electric field may be applied to both induce a phase transformation from the alpha phase to the beta phase and encourage alignment of the beta phase crystals.

A corona poling method may be used to align beta phase crystals within a PVDF fiber, and may include applying a voltage across a selected dimension of a spun fiber. An applied poling voltage may be at least approximately 200 V/micrometer, e.g., 200, 300, 400, 500, or 600 V/micrometer, including ranges between any of the foregoing values. In some cases, electric poling such as corona poling may be performed during or after the act of orienting (stretching). In some cases, electric poling such as corona poling may be performed during the act of annealing. The applied voltage may be applied along a radial direction of a fiber, i.e., perpendicular or substantially perpendicular to a length direction of the fiber. Example poling times may range from approximately 1 min to approximately 180 min. During poling, a crystalline polymer fiber may be heated to a temperature of from approximately 20° C. to approximately 5° C. below the Curie temperature of the polymer.

As used herein, a “fiber” may be characterized by an aspect ratio (length dimension/cross sectional dimension) of at least approximately 10. In accordance with various embodiments, a polymer fiber thin film may be formed by knitting, weaving, or embroidering constituent fibers. By way of example, a polymer fiber thin film may be formed by laying up a plurality of fibers, e.g., in a parallel or overlapping array, enveloping the fibers in a cross-linkable resin, and curing the resin. Example resins may include acrylates, epoxies, and urethanes. Curing may be conducted by exposure to actinic radiation, UV light, e-beam radiation, or heat, optionally in conjunction with a catalyst.

In accordance with various embodiments, anisotropic polymer thin films may include fibrous, amorphous, partially crystalline, or wholly crystalline materials. Such materials may also be mechanically anisotropic, where one or more characteristics may include compressive strength, tensile strength, shear strength, yield strength, stiffness, hardness, toughness, ductility, machinability, thermal expansion, piezoelectric response, and creep behavior may be directionally dependent.

According to some embodiments, the areal dimensions (i.e., length and width) of an oriented crystalline polymer thin film may independently range from approximately 5 cm to approximately 50 cm or more, e.g., 5, 10, 20, 30, 40, or 50 cm, including ranges between any of the foregoing values. Example polymer thin films may have areal dimensions of approximately 5 cm×5 cm, 10 cm×10 cm, 20 cm×20 cm, 50 cm×50 cm, 5 cm×10 cm, 10 cm×20 cm, 10 cm×50 cm, etc.

The presently disclosed crystalline polymer thin films may be characterized as optical quality polymer thin films and may form, or be incorporated into, an optical element such as an actuatable layer. Such optical elements may be used in various display devices, such as virtual reality (VR) and augmented reality (AR) glasses and headsets. The efficiency of these and other optical elements may depend on the degree of optical clarity and/or piezoelectric response.

According to various embodiments, an “optical quality” or “optical grade” polymer article may, in some examples, be characterized by a transmissivity within the visible light spectrum of at least approximately 20%, e.g., 20, 30, 40, 50, 60, 70, 80, 90 or 95%, including ranges between any of the foregoing values, and less than approximately 10% bulk haze, e.g., 0, 1, 2, 4, 6, or 8% bulk haze, including ranges between any of the foregoing values. Transparent materials will typically exhibit very low optical absorption and minimal optical scattering. In some embodiments, an optical quality or optical grade polymer article may be colorless.

As used herein, the terms “haze” and “clarity” may refer to an optical phenomenon associated with the transmission of light through a material, and may be attributed, for example, to the refraction of light within the material, e.g., due to secondary phases or porosity and/or the reflection of light from one or more surfaces of the material. As will be appreciated by those skilled in the art, haze may be associated with an amount of light that is subject to wide angle scattering (i.e., at an angle greater than 2.5° from normal) and a corresponding loss of transmissive contrast, whereas clarity may relate to an amount of light that is subject to narrow angle scattering (i.e., at an angle less than 2.5° from normal) and an attendant loss of optical sharpness or “see through quality.”

Aspects of the present disclosure thus relate to the formation of single layer and multilayer crystalline polymer thin films and crystalline polymer fibers. Methods of forming the crystalline polymer thin films and fibers include stretching and orienting in a thermally dynamic environment. In particular embodiments, a temperature of a crystallizable polymer thin film or fiber is increased during an act of stretching. The presently-disclosed strain-hardened polymer articles may advantageously exhibit spatially uniform optical, mechanical, and/or thermal properties.

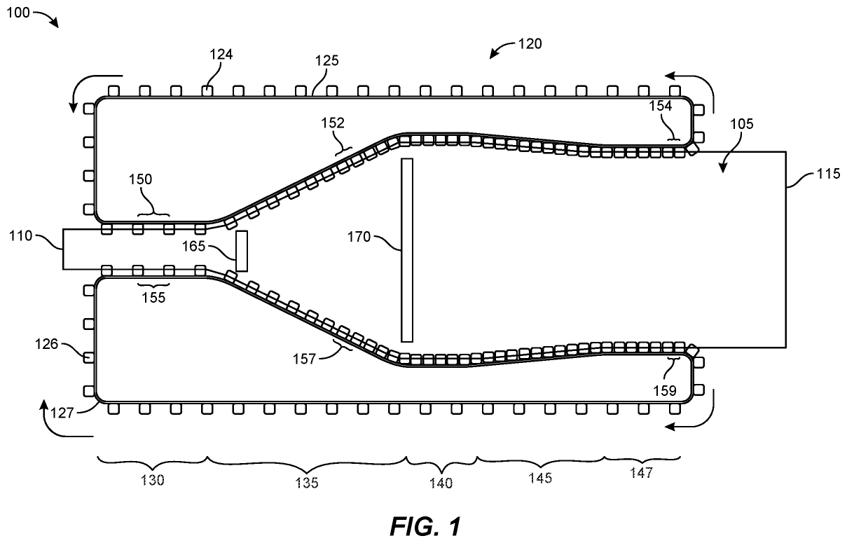

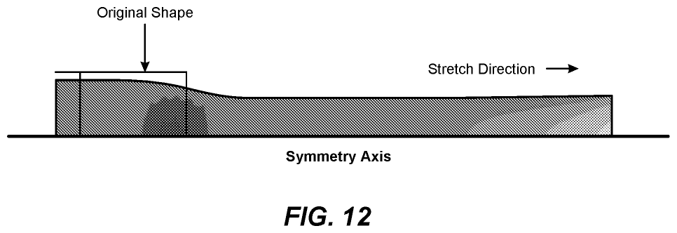

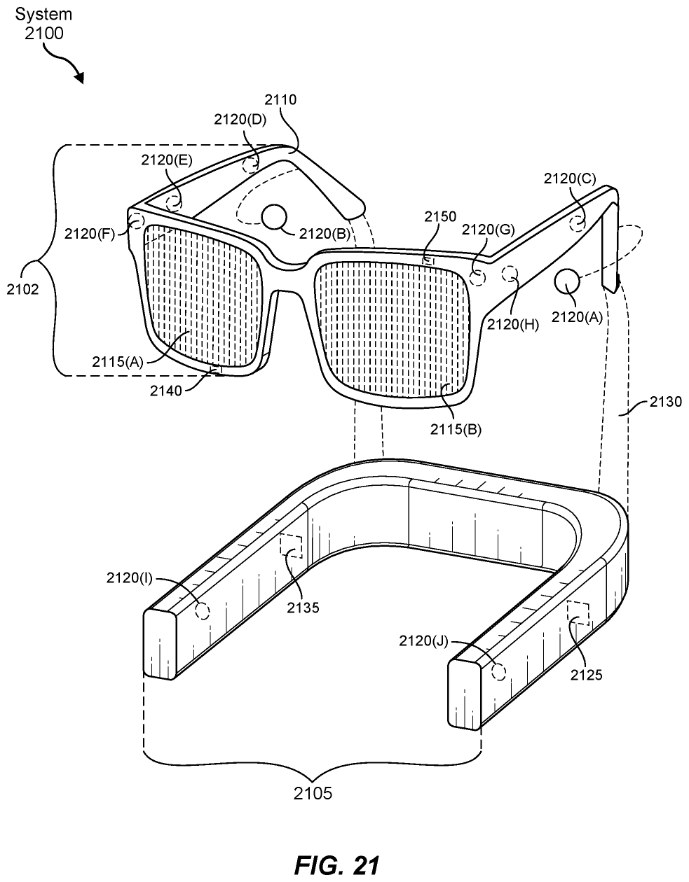

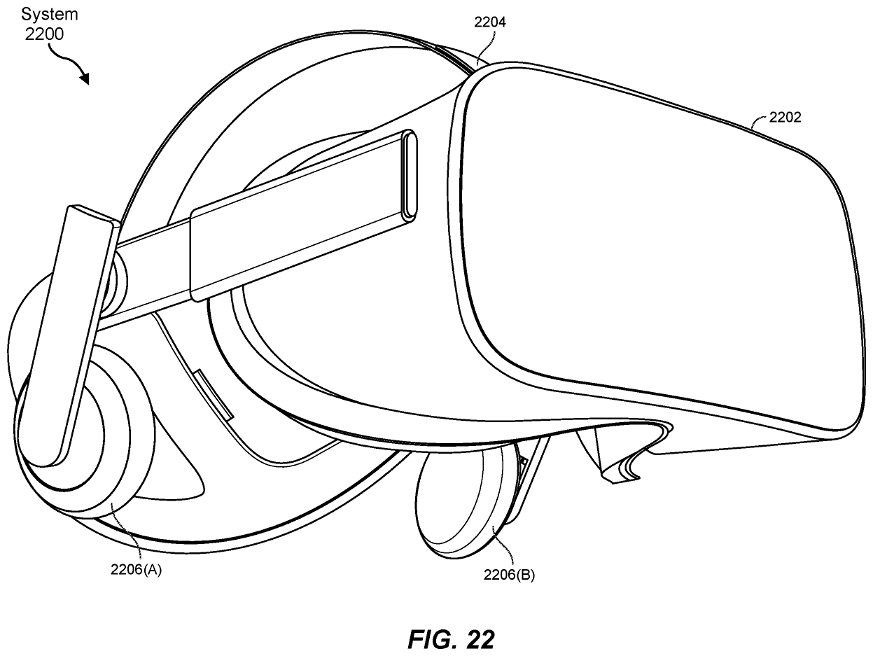

The following will provide, with reference to FIGS. 1-22, a detailed description of length orientation systems for manufacturing polymer thin films having high stretch ratio uniformity. The discussion associated with FIGS. 1-11 relates to example polymer thin film stretching paradigms and associated stretching apparatus. The discussion associated with FIGS. 12-20 relates to the formation and characterization of oriented crystalline polymer thin films and fibers. The discussion associated with FIGS. 21 and 22 relates to exemplary virtual reality and augmented reality devices that may include one or more oriented crystalline polymer thin films or fibers as disclosed herein.

A single stage thin film orientation system for forming an optical grade polymer thin film is shown schematically in FIG. 1. System 100 may include a thin film input zone 130 for receiving and pre-heating a crystallizable portion 110 of a polymer thin film 105, a thin film output zone 147 for outputting a crystallized and oriented portion 115 of the polymer thin film 105, and a clip array 120 extending between the input zone 130 and the output zone 147 that is configured to grip and guide the polymer thin film 105 through the system 100, i.e., from the input zone 130 to the output zone 147. Clip array 120 may include a plurality of movable first clips 124 that are slidably disposed on a first track 125 and a plurality of movable second clips 126 that are slidably disposed on a second track 127.

During operation, proximate to input zone 130, clips 124, 126 may be affixed to respective edge portions of polymer thin film 105, where adjacent clips located on a given track 125, 127 may be disposed at an inter-clip spacing 150, 155. For simplicity, in the illustrated view, the inter-clip spacing 150 along the first track 125 within input zone 130 may be equivalent or substantially equivalent to the inter-clip spacing 155 along the second track 127 within input zone 130. As will be appreciated, in alternate embodiments, within input zone 130, the inter-clip spacing 150 along the first track 125 may be different than the inter-clip spacing 155 along the second track 127.

In addition to input zone 130 and output zone 147, system 100 may include one or more additional zones 135, 140, 145, etc., where each of: (i) the translation rate of the polymer thin film 105, (ii) the shape of first and second tracks 125, 127, (iii) the spacing between first and second tracks 125, 127, (iv) the inter-clip spacing 150, 152, 154, 155, 157, 159, and (v) the local temperature of the polymer thin film 105, etc. may be independently controlled.

In an example process, as it is guided through system 100 by clips 124, 126, polymer thin film 105 may be heated to a selected temperature within each of zones 130, 135, 140, 145, 147. Fewer or a greater number of thermally controlled zones may be used. As illustrated, within zone 135, first and second tracks 125, 127 may diverge along a transverse direction such that polymer thin film 105 may be stretched in the transverse direction while being heated, for example, to a temperature greater than its glass transition temperature (Tg) but less than the onset of melting.

Referring still to FIG. 1, within zone 135 the spacing 152 between adjacent first clips 124 on first track 125 and the spacing 157 between adjacent second clips 126 on second track 127 may decrease relative to the inter-clip spacing 150, 155 within input zone 130. In certain embodiments, the decrease in clip spacing 152, 157 from the initial spacing 150, 155 may scale approximately as the square root of the transverse stretch ratio. The actual ratio may depend on the Poisson's ratio of the polymer thin film as well as the requirements for the stretched thin film, including flatness, thickness, etc. Accordingly, in some embodiments, the in-plane axis of the polymer thin films that is perpendicular to the stretch direction may relax by an amount equal to the square root of the stretch ratio in the stretch direction. By decreasing the clip spacings 152, 157 relative to inter-clip spacing 150, 155 the polymer thin film may be allowed to relax along the machine direction while being stretched along the transverse direction.

A temperature of the polymer thin film may be controlled within each heating zone. Withing stretching zone 135, for example, a temperature of the polymer thin film 105 may be constant or independently controlled within sub-zones 165, 170, for example. In some embodiments, the temperature of the polymer thin film 105 may be decreased as the stretched polymer thin film 105 enters zone 140. Rapidly decreasing the temperature (i.e., thermal quenching) following the act of stretching within zone 135 may enhance the conformability of the polymer thin film 105. In some embodiments, the polymer thin film 105 may be thermally stabilized, where the temperature of the polymer thin film 105 may be controlled within each of the post-stretch zones 140, 145, 147. A temperature of the polymer thin film may be controlled by forced thermal convection or by radiation, for example, IR radiation, or a combination thereof.

Downstream of stretching zone 135, according to some embodiments, a transverse distance between first track 125 and second track 127 may remain constant or, as illustrated, initially decrease (e.g., within zone 140 and zone 145) prior to assuming a constant separation distance (e.g., within output zone 147). In a related vein, the inter-clip spacing downstream of stretching zone 135 may increase or decrease relative to inter-clip spacing 152 along first track 125 and inter-clip spacing 157 along second track 127. For example, inter-clip spacing 155 along first track 125 within output zone 147 may be less than inter-clip spacing 152 within stretching zone 135, and inter-clip spacing 159 along second track 127 within output zone 147 may be less than inter-clip spacing 157 within stretching zone 135. According to some embodiments, the spacing between the clips may be controlled by modifying the local velocity of the clips on a linear stepper motor line, or by using an attachment and variable clip spacing mechanism connecting the clips to the corresponding track.

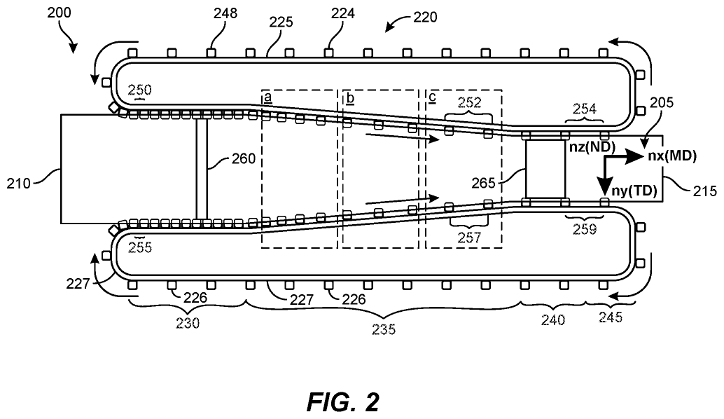

To facilitate cross-stretch relaxation while stretching in the TD direction, the inter-clip spacings 152, 157 withing stretching zone 135 may be decreased by at least approximately 20% (e.g., 20%, 30%, 40%, or 50% or more) relative to respective inter-clip spacings 150, 155 within input zone 130. The relaxation profile may be constant or variable, i.e., as a function of position, across stretching zone 135. According to some embodiments, a maximum TD draw ratio within stretching zone 135 be at least approximately 2 and less than approximately 4. The stretched and oriented polymer thin film 115 may be removed from system 100 and stretched in a further stretching step, such as via length orientation with relaxation as shown in FIG. 2.

Referring to FIG. 2, shown is a further example system for forming an optical grade polymer thin film. Thin film orientation system 200 may include a thin film input zone 230 for receiving and pre-heating a crystalline or crystallizable portion 210 of a polymer thin film 205, a thin film output zone 245 for outputting an at least partially crystallized and oriented portion 215 of the polymer thin film 205, and a clip array 220 extending between the input zone 230 and the output zone 245 that is configured to grip and guide the polymer thin film 205 through the system 200. As in the previous embodiment, clip array 220 may include a plurality of first clips 224 that are slidably disposed on a first track 225 and a plurality of second clips 226 that are slidably disposed on a second track 227. In certain embodiments, crystalline or crystallizable portion 210 may correspond to stretched and oriented polymer thin film 115.

In an example process, proximate to input zone 230, first and second clips 224, 226 may be affixed to edge portions of polymer thin film 205, where adjacent clips located on a given track 225, 227 may be disposed at an initial inter-clip spacing 250, 255, which may be substantially constant or variable along both tracks within input zone 230. Within input zone 230 a distance along the transverse direction between first track 225 and second track 227 may be constant or substantially constant.

System 200 may additionally include one or more zones 235, 240, etc. The dynamics of system 200 allow independent control over: (i) the translation rate of the polymer thin film 205, (ii) the shape of first and second tracks 225, 227, (iii) the spacing between first and second tracks 225, 227 along the transverse direction, (iv) the inter-clip spacing 250, 255 within input zone 230 as well as downstream of the input zone (e.g., inter-clip spacings 252, 254, 257, 259), and (v) the local temperature of the polymer thin film, etc.

In an example process, as it is guided through system 200 by clips 224, 226, polymer thin film 205 may be heated to a selected temperature within each of zones 230, 235, 240, 245. A temperature greater than the glass transition temperature of a component of the polymer thin film 205 may be used during deformation (i.e., within zone 235), whereas a lesser temperature, an equivalent temperature, or a greater temperature may be used within each of one or more downstream zones.

As in the previous embodiment, the temperature of the polymer thin film 205 within stretching zone 235 may be locally controlled. According to some embodiments, the temperature of the polymer thin film 205 may be maintained at a constant or substantially constant value during the act of stretching. According to further embodiments, the temperature of the polymer thin film 205 may be incrementally increased within stretching zone 235. That is, the temperature of the polymer thin film 205 may be increased within stretching zone 235 as it advances along the machine direction. By way of example, the temperature of the polymer thin film 205 within stretching zone 235 may be locally controlled within each of heating zones a, b, and c.

The temperature profile may be continuous, discontinuous, or combinations thereof. As illustrated in FIG. 2, heating zones a, b, and c may extend across the width of the polymer thin film 205, and the temperature within each zone may be independently controlled according to the relationship Tg<Ta<Tb<Tc<Tm. A temperature difference between neighboring heating zones may be less than approximately 20° C., e.g., less than approximately 10° C., or less than approximately 5° C.

Referring still to FIG. 2, within zone 235 the spacing 252 between adjacent first clips 224 on first track 225 and the spacing 257 between adjacent second clips 226 on second track 227 may increase relative to respective inter-clip spacings 250, 255 within input zone 230, which may apply an in-plane tensile stress to the polymer thin film 205 and stretch the polymer thin film along the machine direction. Moreover, the extent of inter-clip spacing on one or both tracks 225, 227 within deformation zone 235 may be constant or variable and, for example, increase as a function of position along the machine direction.

Within stretching zone 235, the inner-clip spacings 252, 257 may increase linearly such that the primary mode of deformation may be at constant velocity. For example, a strain rate of the polymer thin film may decrease along the machine direction. In further embodiments, the polymer thin film 205 may be stretched at a constant strain-rate where the inter-clip spacing may increase exponentially.

In certain examples, a progressively decreasing strain rate may be implemented with thin film orientation system 200 to generate a high refractive index polymer thin film. For instance, within stretching zone 235 an inter-clip spacing may be configured such that a distance between each successive pair of clips 224, 226 increases along the machine direction. The inter-clip spacing between each successive pair of clips may be independently controlled to achieve a desired strain rate along the machine direction.

In response to the tensile stress applied along the machine direction, system 200 is configured to inhibit the generation of stresses and an attendant realignment of crystals along the machine direction. As illustrated, within zone 235, first and second tracks 225, 227 may converge along a transverse direction such that polymer thin film 205 may relax in the transverse direction while being stretched in the machine direction. Using a single stretching step or multiple stretching steps, polymer thin film 205 may be stretched by a factor of at least approximately 4 (e.g., 4, 5, 6, 7, 8, 9, 10, 20, 40, 100, or more, including ranges between any of the foregoing values).

Within stretching zone 235, an angle of inclination of first and second tracks 225, 227 (i.e., with respect to the machine direction) may be constant or variable. In particular examples, the inclination angle within stretching zone 235 may decrease along the machine direction. That is, according to certain embodiments, the inclination angle within heating zone a may be greater than the inclination angle within heating zone b, and the inclination angle within heating zone b may be greater than the inclination angle within heating zone c. Such a configuration may be used to provide a progressive decrease in the relaxation rate (along the transverse direction) within the stretching zone 235 as the polymer thin film advances through system 200.

In some embodiments, the temperature of the polymer thin film 205 may be decreased as the stretched polymer thin film 205 exits zone 235. In some embodiments, the polymer thin film 205 may be thermally stabilized, where the temperature of the polymer thin film 205 may be controlled within each of the post-deformation zones 240, 245. A temperature of the polymer thin film may be controlled by forced thermal convection or by radiation, for example, IR radiation, or a combination thereof.

Downstream of deformation zone 235, the inter-clip spacing may increase or remain substantially constant relative to inter-clip spacing 252 along first track 225 and inter-clip spacing 257 along second track 227. For example, inter-clip spacing 255 along first track 225 within output zone 245 may be substantially equal to the inter-clip spacing 252 as the clips exit zone 235, and inter-clip spacing 259 along second track 227 within output zone 245 may be substantially equal to the inter-clip spacing 257 as the clips exit zone 235. Following the act of stretching, polymer thin film 205 may be annealed, for example, within one or more downstream zones 240, 245.

The strain impact of the thin film orientation system 200 is shown schematically by unit segments 260, 265, which respectively illustrate pre- and post-deformation dimensions for a selected area of polymer thin film 205. In the illustrated embodiment, polymer thin film 205 has a pre-stretch width (e.g., along the transverse direction) and a pre-stretch length (e.g., along the machine direction). As will be appreciated, a post-stretch width may be less than the pre-stretch width and a post-stretch length may be greater than the pre-stretch length.

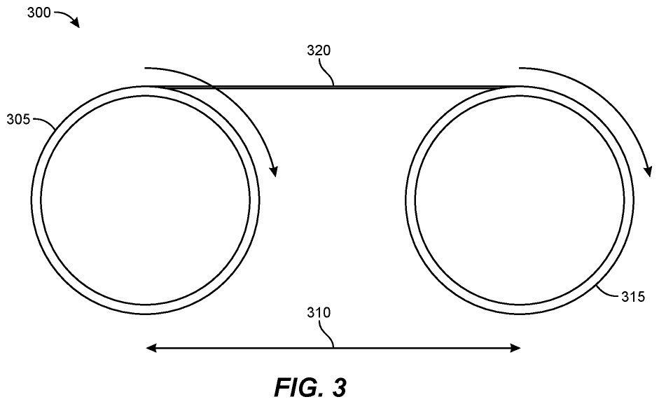

In some embodiments, a roll-to-roll system may be integrated with a thin film orientation system, such as thin film orientation system 100 or thin film orientation system 200, to manipulate a polymer thin film. In further embodiments, as illustrated herein with reference to FIG. 3, a roll-to-roll system may itself be configured as a thin film orientation system.

An example roll-to-roll polymer thin film orientation system is depicted in FIG. 3. In conjunction with system 300, a method for stretching a polymer thin film 320 may include mounting the polymer thin film between linear rollers 305, 315 and heating a portion of the polymer thin film located between the rollers 305, 315 to a temperature greater than its glass transition temperature. Rollers 305, 315 may be arranged with a controllable spacing 310 therebetween. A heat source (not shown), such as an IR source optionally equipped with an IR reflector, may be used to heat the polymer thin film 320 within a deformation region between the rollers.

While controlling the temperature of the polymer thin film, rollers 305, 315 may be engaged and the polymer thin film may be stretched. For instance, first roller 305 may rotate at a first rate and second roller 315 may rotate at a second rate greater than the first rate to stretch the polymer thin film along a machine direction therebetween. Within a deformation zone between rollers, system 300 may be configured to locally control the temperature and the strain rate of the polymer thin film. In some examples, as the polymer thin film advances from roller 305 to roller 315, a temperature of the polymer thin film may increase, and a strain rate of the polymer thin film may decrease. Downstream of roller 315, the polymer thin film may then be cooled while maintaining the applied stress. System 300 may be used to form a uniaxially oriented polymer thin film. Additional rollers may be added to system 300 to control the conveyance and take-up of the polymer thin film.

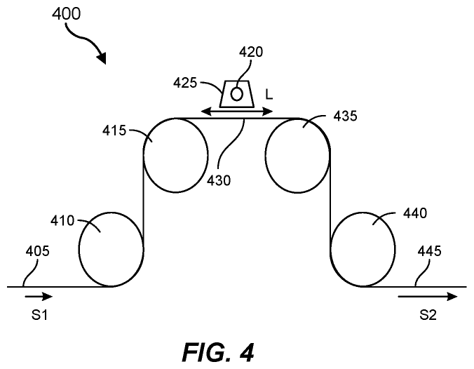

Referring to FIG. 4, shown is a schematic cross-sectional illustration of an example length orientation system. Length orientation system 400 includes feeder rollers 410, 415, take-up rollers 435, 440, and a heating element 420 positioned proximate to an inter roller gap 430 between the second feeder roller 415 and the first take-up roller 435. Heating element 420 may include an infrared lamp, for example. The rollers are configured to guide a crystallizable or partially crystalline polymer thin film 405 through the system 400.

Heating element 420 is configured to heat the thin film 405 as it traverses the inter roller gap 430. Heating element 420 may include a reflector 425. Reflector 425 may improve heating of the thin film 405. In some embodiments, the heating element 420 is configured to heat an entire width of the thin film (i.e., along a transverse direction) as the thin film moves through the gap 430 (i.e., along a machine direction).

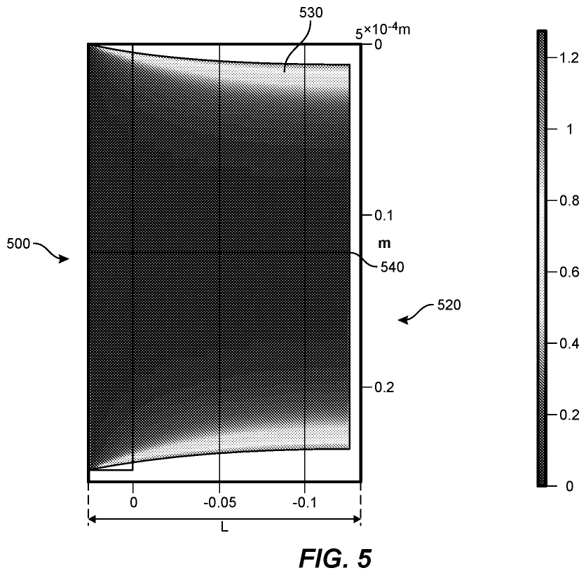

During operation, the rotational rate of the feeder rollers 410, 415 may be less than the rotational rate of the take-up rollers 435, 440, such that the speed (S1) of the thin film entering the gap 430 may be less than the speed (S2) of the thin film exiting the gap. The speed differential may cause stretching of the thin film along its length (L) within the gap 430 and the formation of an oriented polymer thin film 445. A strain map of a polymer thin film stretched using length orientation system 400 is shown in FIG. 5.

Referring to FIG. 5, shown is a top-down view of a strain map for a stretched polymer thin film within the inter roller gap of system 400. The position of the first take-up roller is denoted by reference numeral 520. Stretching along a length direction (L) induces a lateral relaxation between the edge 530 and the centerline 540 of the thin film. The data show the ratio of relaxation in the width direction to relaxation in the thickness (out-of-plane) direction, and show that the stretch ratio from edge to center is relatively uniform, with a notable transition proximate to the edges of the thin film.

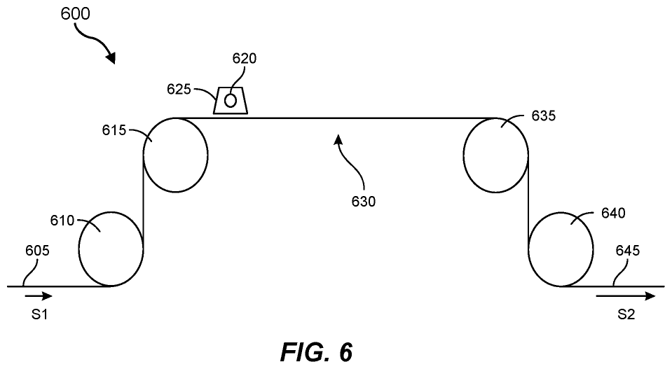

A schematic cross-sectional illustration of a further example length orientation system is shown in FIG. 6. Length orientation system 600 includes feeder rollers 610, 615, take-up rollers 635, 640, and a heating element 620 positioned proximate to second feeder roller 615 within an inter roller gap 630 between the second feeder roller 615 and the first take-up roller 635. Inter roller gap 630 in system 600 is larger than inter roller gap 430 in system 400. As in the previous embodiment, the rollers are configured to guide a crystallizable or partially crystalline polymer thin film 605 through the system 600.

Heating element 620 is configured to heat the thin film 605 as it traverses the inter roller gap 630. Heating element 620 may include a reflector 625. Reflector 625 may improve heating of the thin film 605. In some embodiments, the heating element 620 is configured to heat an entire width of the thin film (i.e., along a transverse direction) as the thin film moves across the gap 630.

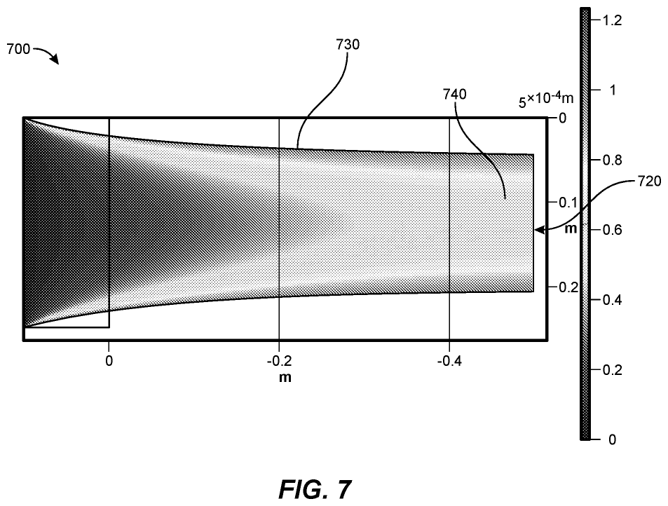

During operation, the rotational rate of the feeder rollers 610, 615 may be less than the rotational rate of the take-up rollers 635, 640, such that the speed (S1) of the thin film entering the gap 630 may be less than the speed (S2) of the thin film exiting the gap. The speed differential may cause stretching of the thin film along its length (L) within the gap 630 and the formation of an oriented polymer thin film 645. A strain map of a polymer thin film stretched using length orientation system 600 is shown in FIG. 7.

Referring to FIG. 7, shown is a top-down view of a strain map for a stretched polymer thin film. The position of the first take-up roller is denoted by reference numeral 720. Stretching along a length direction (L) induces a lateral relaxation between the edge 730 and the centerline 740 of the thin film. The data show the ratio of relaxation in the width direction to relaxation in the thickness (out-of-plane) direction, and describe a thin film having improved uniaxial orientation characteristics relative to the thin film processed using system 400.

With reference to FIGS. 4-7, it will be appreciated that a relatively small inter roller gap (e.g., gap 430 in system 400) may promote film uniformity, whereas the associated constraint on lateral shrinkage may generate a biaxially-oriented thin film or a thin film having more biaxial character than uniaxial character. In comparison, a relatively large inter roller gap (e.g., gap 630 in system 600) may permit lateral (widthwise) relaxation of the thin film during stretching and promote the formation of a uniaxial polymer thin film, but may also contribute adversely to the uniformity (i.e., direction uniformity) of one or more in-plane properties.

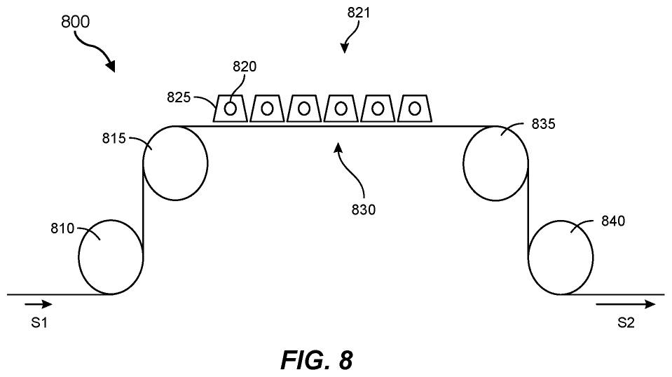

Turning to FIG. 8, shown is a cross-sectional schematic view of a further example length orientation system. Length orientation system 800 includes feeder rollers 810, 815, take-up rollers 835, 840, and a heating element array 821 located proximate to a relatively large inter roller gap 830. Heating element array 821 includes plural heating elements 820 distributed along a machine direction of the length orientation system 800 between the second feeder roller 815 and the first take-up roller 835. Heating elements 820 may each include a reflector 825. The heating element array 821 may be configured to extend the area within gap 830 over which the polymer thin film may be stretched, as well as provide a dynamic (increasing) temperature profile along the machine direction of the length orientation system.

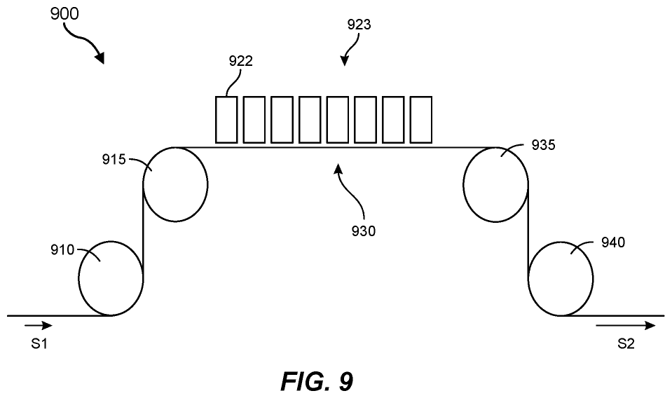

Referring to FIG. 9, a further example length orientation system 900 includes feeder rollers 910, 915, take-up rollers 935, 940, and a heating element array 923 located proximate to a relatively large inter roller gap 930. Heating element array 923 includes plural heating elements 922, such as forced fluid heating elements. The heating element array 923 may be configured to extend the area within gap 930 over which the polymer thin film may be stretched, as well as provide a dynamic (increasing) temperature profile along the machine direction.

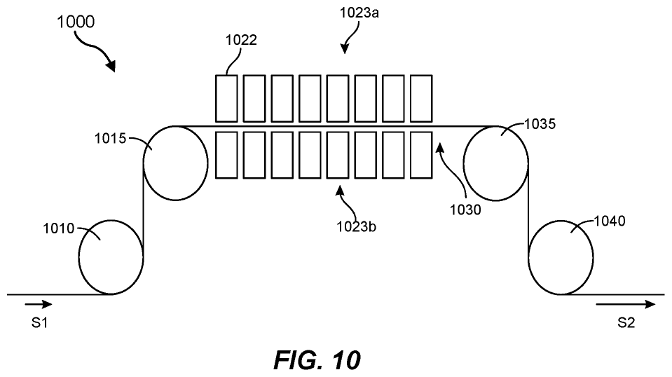

A length orientation system having a double-sided array of heating elements is depicted in FIG. 10. Length orientation system 1000 includes feeder rollers 1010, 1015, take-up rollers 1035, 1040, and a pair of heating element arrays 1023a, 1023b located adjacent to respective opposing sides of a polymer thin film within a relatively large inter roller gap 1030. Heating element arrays 1023a, 1023b include plural heating elements 1022, such as forced fluid heating elements, which may be independently controlled to provide a dynamic (increasing) temperature within and across inter roller gap 1030. By providing heating elements on both sides of the polymer thin film, temperature control including temperature uniformity may be improved.

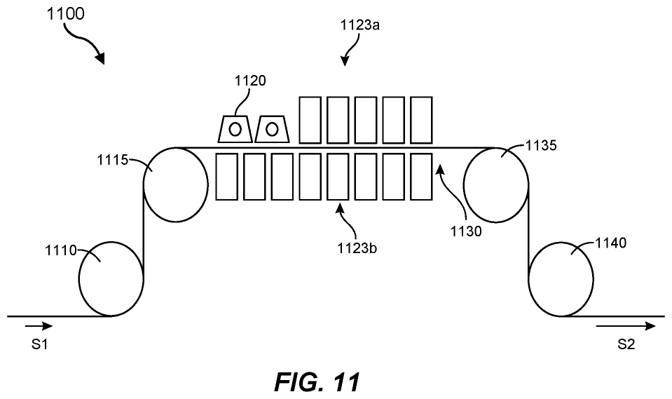

A further example length orientation system may include a hybrid configuration of heating elements. For instance, IR lamps and forced fluid heating elements may be combined in one or more heating element arrays to control the temperature of a polymer thin film passing through the system. Referring to FIG. 11, shown is such a length orientation system. Length orientation system 1100 includes feeder rollers 1110, 1115, take-up rollers 1135, 1140, and a pair of heating element arrays 1123a, 1123b located adjacent to respective opposing sides of a polymer thin film within a relatively large inter roller gap 1130. Heating element arrays 1123a, 1123b may each include plural heating elements. In the illustrated embodiment, heating element array 1123a includes IR lamps 1120 located proximate to second input roller 1115 and forced fluid heating elements 1122 located downstream of the IR lamps. The various heating elements may be independently controlled to provide a dynamic (increasing) temperature within and across inter roller gap 1130.

The heating elements may provide a uniform temperature across the width of the polymer thin film. Alternatively, in some instances, the heating elements may provide a temperature differential along the width direction. A cross-width temperature difference may be configured such that the thin film temperature may be higher at the edges of the thin film, or higher along the centerline, with a maximum temperature difference of approximately 1° C. to approximately 40° C. A temperature difference along the width direction can result in improved uniaxial stretched film behavior depending on the stress-strain hardening behavior of the polymer.

Aspects of a finite element model used to evaluate the performance of various length orientation systems and the characteristics of oriented crystalline polymer thin films are discussed below with reference to FIGS. 12-18. Referring to FIG. 12, the model illustrates the in-plane deformation of a crystallizable polymer thin film located between two rollers in response to differential roller speeds and differential heating across an inter roller gap. The model is simplified without loss of generality by omitting the rollers and modeling extra sections of the polymer thin film starting from a short rectangular film strip and stretching until near steady-state deformation is achieved.

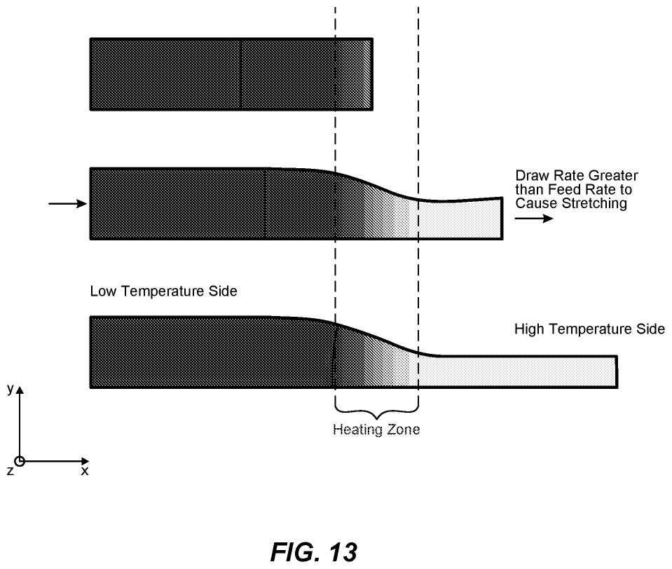

Referring to FIG. 13, a selected region of the polymer thin film is designated by the model as the heating zone and the selected region is heated from low to high temperature as it crosses this zone. Heating decreases the yield stress and hardening stress of the polymer. The model assumes the yield stress and the hardening stress decrease by an equivalent amount. A “stretch ratio” along a given direction of a polymer thin film is defined as the post-stretch dimension divided by the pre-stretch dimension. A “biaxial stretch ratio” is defined as the elongation in the transverse (y-axis) dimension divided by the elongation in the thickness (z-axis) dimension. The biaxial stretch ratio may be alternatively expressed as (stretch amount (y)−1)/(stretch amount (z)−1), which for a true uniaxial thin film is unity.

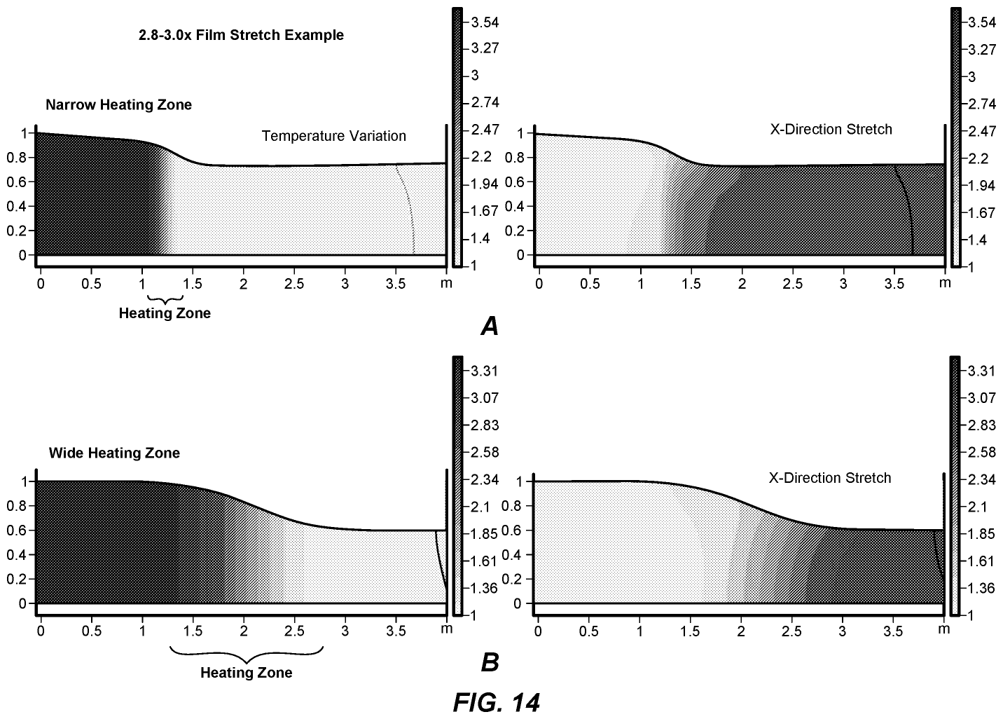

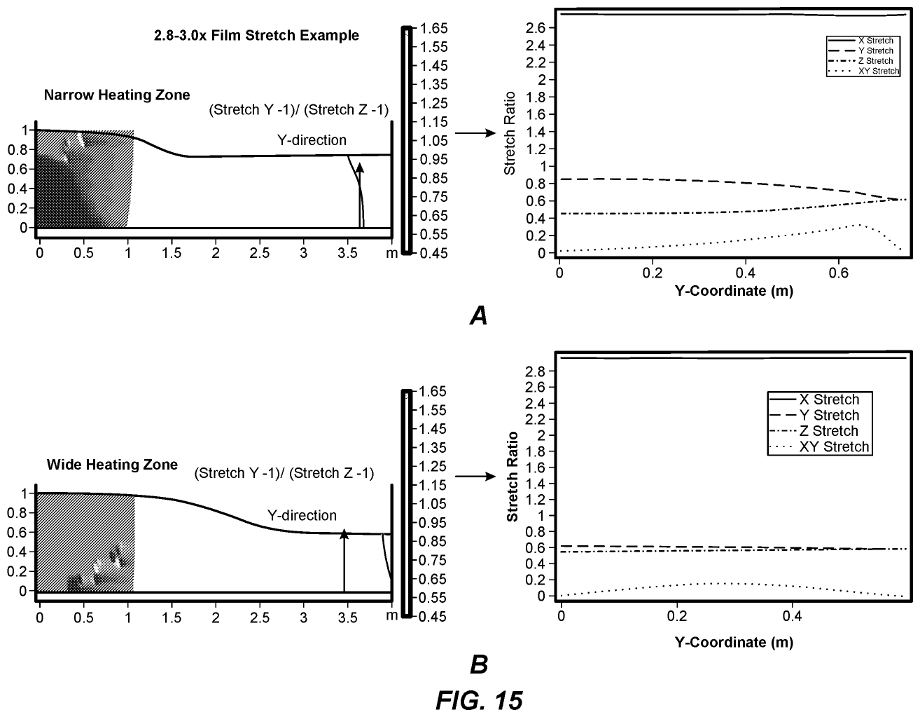

Referring to FIG. 14, shown are modeled data for crystallizable polymer thin films stretched with a relatively low target stretch ratio of 2.8-3.0 using (A) a length orientation system having a relatively narrow heating zone (e.g., length orientation system 400) or (B) a length orientation system having a relatively wide heating zone (e.g., length orientation system 600, 800, 900, 1000, or 1100). By heating across a narrow heating zone, the resulting thin film has a non-uniform biaxial stretch ratio. By heating across a wide heating zone, on the other hand, the resulting thin film has improved uniformity across the transverse dimension and a stretch ratio consistent with a uniaxial orientation. Additional data comparing the effects of stretching within a narrow versus a wide heating zone are shown in FIG. 15.

FIG. 15 shows a correlation between stretching across a narrow heating zone with non-uniform stretching and the formation of a biaxially-oriented thin film, whereas stretching across a wide heating zone results in an improved uniaxial orientation as is evident from the nearly equal strain in the y and z directions and the very low x-y shear.

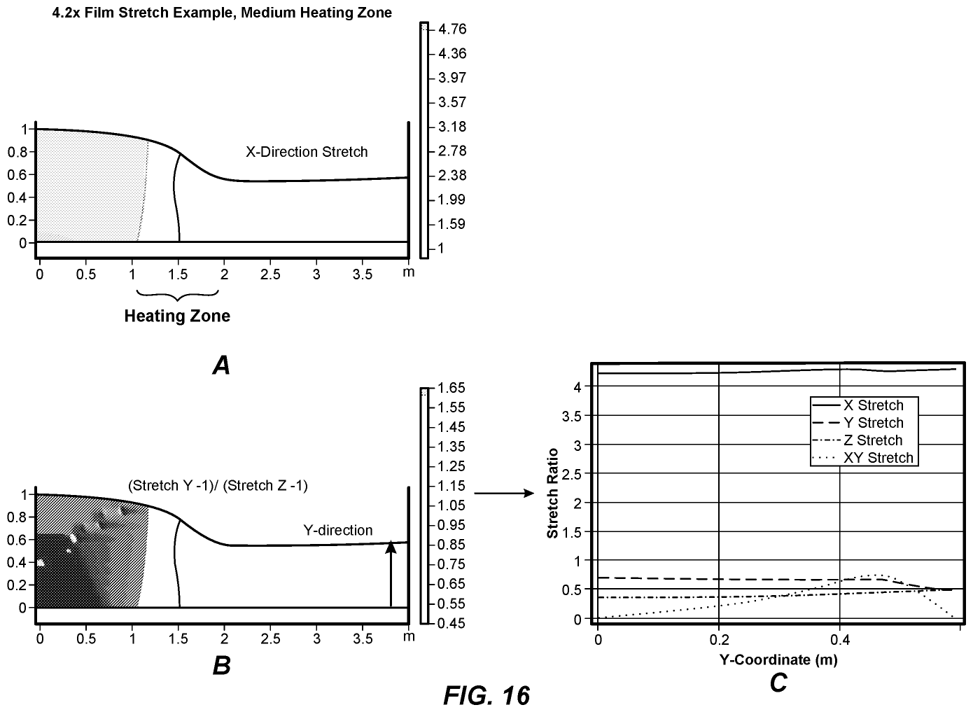

Referring to FIG. 16, shown are modeled data for crystallizable polymer thin films stretched with a target stretch ratio of 4.2 using a length orientation system having a medium width heating zone (FIG. 16A). The biaxial stretch ratio shown in FIG. 16B is non-uniform and unequal to unity within the heating zone, and the stretch ratios shown in FIG. 16C are also non-uniform. Moreover, the stretch ratios along the y and z dimensions are unequal and the shear (xy) stretch is significant.

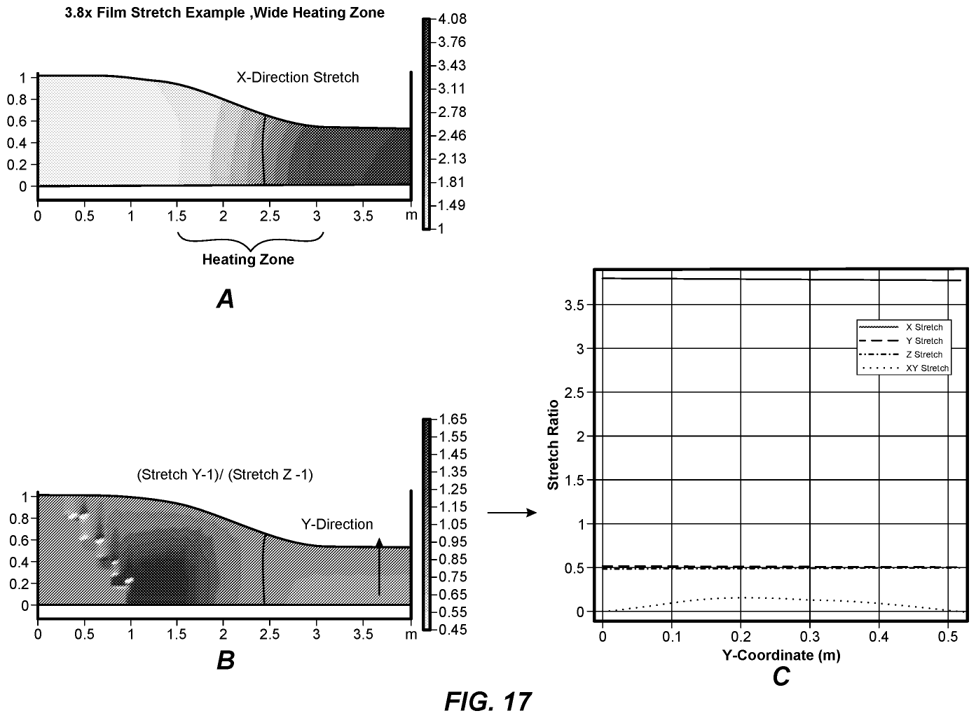

Referring to FIG. 17, shown are modeled data for crystallizable polymer thin films stretched with a target stretch ratio of 3.8 using a length orientation system having a wide heating zone (FIG. 17A). The biaxiality ratio shown in FIG. 17B is uniform and close to unity in the stretched zone. The stretch ratios shown in FIG. 17C are also reasonably uniform along the y-direction, the stretch ratios along the y and z dimensions are nearly equal, and the shear (xy) stretch is small.

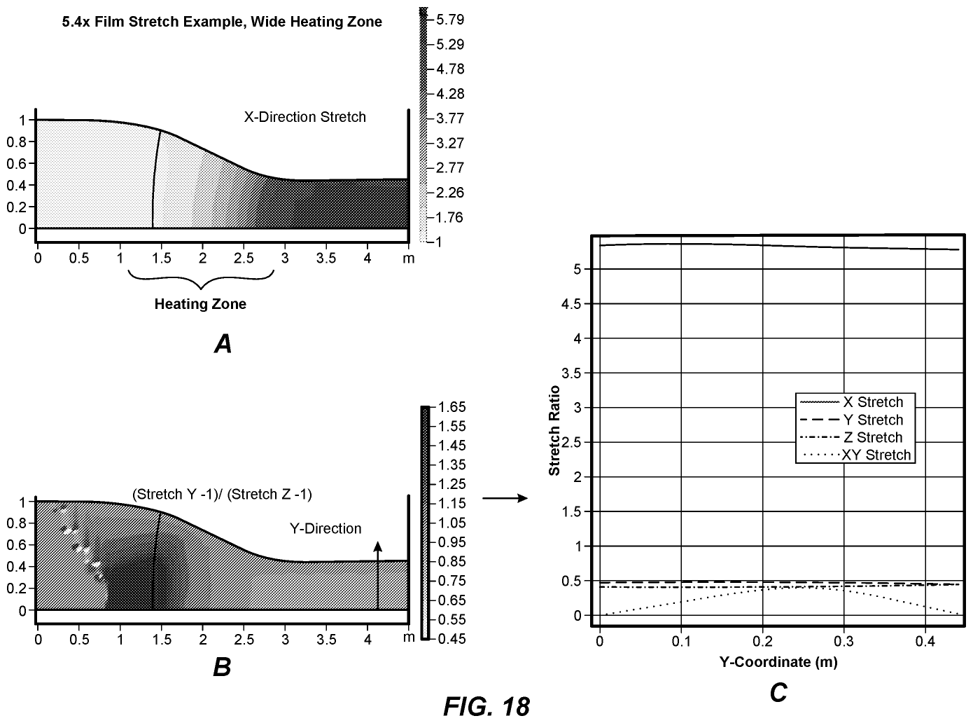

Referring to FIG. 18, shown are modeled data for crystallizable polymer thin films stretched with a target stretch ratio of 5.4 using a length orientation system having a wide heating zone (FIG. 18A). Notwithstanding a more aggressive target stretch ratio, the biaxiality ratio shown in FIG. 18B is uniform and close to unity. The stretch ratios shown in FIG. 18C are also uniform along the y direction, the stretch ratios along the y and z dimensions are nearly equal, and the shear (xy) stretch is small.

The size of the heating zone that is effective to achieve a substantially uniaxially-oriented polymer thin film may be decreased by changing the temperature profile along the rolling direction, such that the film temperature rises more quickly at the start of the rolling process, or at the end of the rolling process, depending on the polymer film stress-strain behavior. The size of the heating zone implemented to achieve a substantially uniaxially-oriented polymer thin film may also be decreased by targeting non-uniform heating across the width of the film as discussed above, such that the temperature proximate to the edges of the film is greater than the temperature proximate to the centerline, or vice versa, depending also on the polymer film stress-strain behavior.

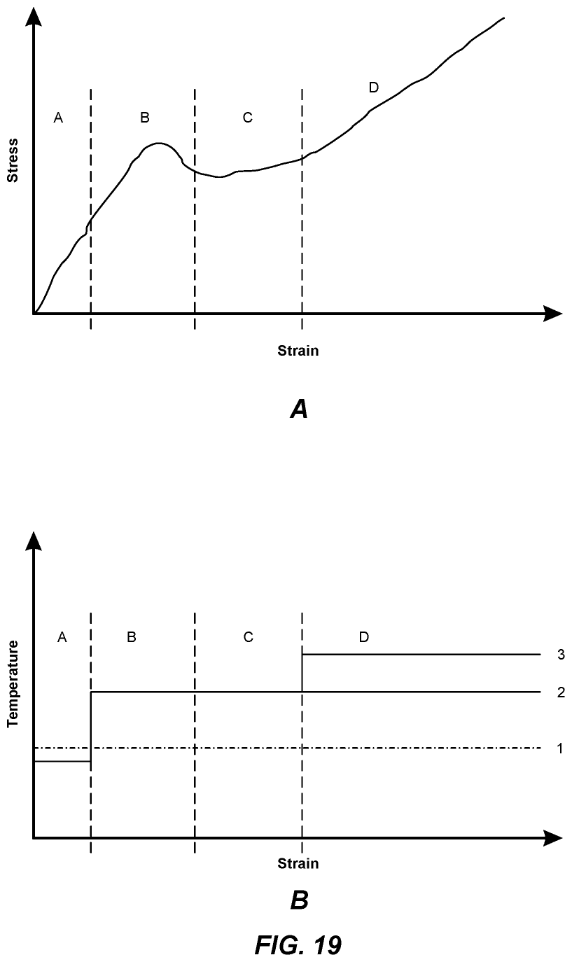

With reference now to FIG. 19, during a process of stretching a crystallizable polymer to form a uniaxially-oriented crystalline polymer thin film, the temperature profile along the length orientation direction may be related to the stress-strain behavior of a chosen polymer. Illustrated in the stress-strain curve of FIG. 19A are the (A) elastic, (B) yield, (C) necking, and (D) plastic deformation regions for a crystallizable polymer. Various temperature-strain profiles are illustrated in FIG. 19B, including a comparative constant temperature profile (profile 1), and step profiles according to various embodiments (profiles 2 and 3).

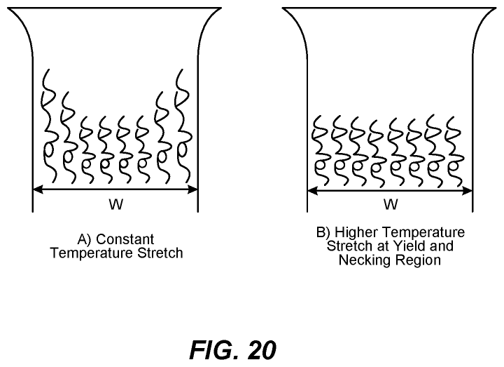

A constant temperature profile (profile 1) throughout the act of stretching may cause necking and an uneven polymer chain orientation profile, as depicted in FIG. 20A. As shown in FIG. 20B, however, increasing the stretch temperature at least at the yield onset and during necking (profile 2 and profile 3) improves polymer chain relaxation and promotes the development of a constant or substantially constant stress across the width of a polymer thin film. Moreover, increasing the stretch temperature within the yield and necking regions relative to the elastic region may increase the achievable final stretch ratio of the polymer.

According to further embodiments, and with reference to FIG. 19B, for a step-change temperature profile paradigm, the stretch temperature within the plastic deformation region may remain unchanged (profile 2) or increased further (profile 3) relative to the stretch temperature in the yield and necking regions.

Although the temperature profiles of FIG. 19B are depicted as step-change profiles, it will be appreciated that a continuous change in temperature is also contemplated, and that a temperature change may or may not be correlated to the yield, necking, or plastic deformation regions of a crystallizable polymer. characteristics

According to various embodiments, an oriented polymer thin film manufactured using a dynamic temperature profile during the acts of stretching and orienting may exhibit one or more property improvements relative to an oriented polymer thin film manufactured using a constant stretching temperature. Example properties may include elastic modulus, yield strength, thermal conductivity, haze, piezoelectric strain coefficient (d₃₁), electromechanical coupling coefficient (k₃₁), refractive index, and birefringence.

By way of example, uniaxially-oriented polyethylene (UA-PE) thin film including untangled polyethylene may have one or more of an elastic modulus of at least approximately 90 GPa, e.g., 90, 110, or 130 GPa, including ranges between any of the foregoing values, a yield strength of at least approximately 1.5 GPa, e.g., 1.5, 2, 2.5, or 3 GPa, including ranges between any of the foregoing values, and a thermal conductivity of at least approximately 30 W/mK, e.g., 30, 40, 50, 60, or 70 W/mK, including ranges between any of the foregoing values.

In comparison, a uniaxially-oriented PE-PE wax thin film may have one or more of an elastic modulus of approximately 10 GPa to approximately 50 GPa, e.g., 10, 30, or 50 GPa, including ranges between any of the foregoing values, a yield strength of approximately 0.4 GPa to approximately 0.8 GPa, e.g., 0.4, 0.6, or 0.8 GPa, including ranges between any of the foregoing values, a thermal conductivity of approximately 2 W/mK to approximately 8 W/mK, e.g., 2, 4, 6, or 8 W/mK, including ranges between any of the foregoing values, and a surface haze (2°) of less than approximately 10%, e.g., 10, 8, 6, 4, 2, 1, or 0.5%, including ranges between any of the foregoing values.

According to further examples, a UA-PVDF thin film may have at least one of an elastic modulus of at least approximately 3 GPa, e.g., 3, 5, 7, 9, 11, or 13 GPa, including ranges between any of the foregoing values, a surface haze (2°) of less than approximately 15%, e.g., 15, 12, 10, 8, 6, 4, 2, 1, or less than 0.5%, including ranges between any of the foregoing values, a piezoelectric strain coefficient (d₃₁) of at least approximately 20 pC/N, e.g., 20, 25, 30, 35, 40, 45 pC/N, or greater, including ranges between any of the foregoing values, and an electromechanical coupling coefficient (k₃₁) of at least approximately 1%, e.g., 1, 2, 4, 6%, or greater, including ranges between any of the foregoing values.

According to still further examples, a UA-PEN thin film may have an extraordinary refractive index of at least approximately 1.8, e.g., 1.8, 1.82, 1.84, 1.86, 1.88, or 1.9, including ranges between any of the foregoing values, and a birefringence of at least approximately 0.15, e.g., 0.15, 0.2, 0.25, or 0.3, including ranges between any of the foregoing values.

Disclosed are a method and apparatus for manufacturing uniaxially oriented polymer thin films and fibers. In an example method, a polymer thin film is heated to a first temperature while an in-plane stress is applied to the thin film to induce a positive strain along a length direction of the film. The polymer thin film is then heated to a second temperature greater than the first temperature while continuing to apply the in-plane stress and induce a further positive strain along the length direction. The extent of the zone within which heating occurs may entirely encompass the thin film along its width and may be relatively large along the length direction of the thin film. For instance, a length of the heating zone may be comparable to a width dimension of the thin film.

By controlling the temperature of the polymer, the magnitude of the applied stress and the associated strain rate, and the dimensions of the heating zone, etc., a uniaxially oriented polymer article having high strain ratio uniformity may be produced. Oriented polymer thin films and fibers may exhibit uniform properties, including mechanical, electrical, thermal, optical, and electro-optic properties, especially along a width dimension of a thin film.

### EXAMPLE EMBODIMENTS

Example 1: A method includes heating a segment of a crystallizable polymer article to a first temperature, applying a stress to the crystallizable polymer article in an amount effective to induce a positive strain within the heated segment of the crystallizable polymer article, and heating the segment of the crystallizable polymer article to a second temperature greater than the first temperature while continuing to apply the stress to the crystallizable polymer article to form a uniaxially oriented crystalline polymer article.
Example 2: The method of Example 1, where heating the crystallizable polymer article includes continuously increasing the temperature from the first temperature to the second temperature.
Example 3: The method of Example 1, where heating the crystallizable polymer article includes discontinuously increasing the temperature from the first temperature to the second temperature.
Example 4: The method of any of Examples 1-3, including conveying the crystallizable polymer article from a feeder roller across a gap to a take-up roller, and applying the stress to the heated segment of the crystallizable polymer article within the gap.
Example 5: The method of Example 4, where a rate of rotation of the feeder roller is less than a rate of rotation of the take-up roller.
Example 6: The method of any of Examples 4 and 5, where the segment of the crystallizable polymer article is heated within the gap.
Example 7: The method of any of Examples 4-6, where heating the segment of the crystallizable polymer article includes heating at least one of the feeder roller and the take-up roller.
Example 8: The method of any of Examples 1-7, including attaching a clip array to opposing edges of the crystallizable polymer article, the clip array including a plurality of first clips slidably disposed on a first track located proximate to a first edge of the crystallizable polymer article and a plurality of second clips slidably disposed on a second track located proximate to a second edge of the crystallizable polymer article, applying the stress to the crystallizable polymer article along a transverse direction by increasing a distance between the first clips and the second clips, and decreasing an inter-clip spacing amongst the first clips and amongst the second clips along a machine direction while applying the stress.
Example 9: The method of Example 8, including decreasing a strain rate of the crystallizable polymer article along the machine direction while applying the stress.
Example 10: The method of any of Examples 8 and 9, where the first and second clips are configured to slide along a parabolic path.
Example 11: The method of any of Examples 1-10, where the crystallizable polymer article includes a thin film or a fiber.
Example 12: The method of any of Examples 1-11, where the crystallizable polymer includes a fluoropolymer.
Example 13: The method of any of Examples 1-12, where the crystallizable polymer includes a polymer selected from polyethylene, polyvinylidene fluoride, and a polyester.
Example 14: The method of any of Examples 1-13, where the crystallizable polymer has a molecular weight of at least approximately 100,000 g/mol.
Example 15: The method of any of Examples 1-14, where the uniaxially oriented crystalline polymer article includes at least one property selected from elastic modulus, yield strength, thermal conductivity, haze, piezoelectric strain coefficient (d₃₁), electromechanical coupling coefficient (k₃₁), refractive index, and birefringence that is improved relative to a crystalline polymer article that is stretched using a constant stretching temperature.
Example 16: A uniaxially-oriented crystalline polymer thin film includes a cross-stretch direction width of at least approximately 0.4 m and (a) variability in elastic modulus of less than approximately 10% across the cross-stretch direction width, or (b) variability in optical axis of less than approximately 5° across the cross-stretch direction width.
Example 17: The uniaxially-oriented crystalline polymer thin film of Example 16, where (a) variability in the elastic modulus is less than approximately 10% across the cross-stretch direction width, and (b) variability in the optical axis is less than approximately 5° across the cross-stretch direction width.
Example 18: The uniaxially-oriented crystalline polymer thin film of any of Examples 16 and 17, where the crystalline polymer includes a polymer selected from polyethylene, polyvinylidene fluoride, and a polyester.
Example 19: The uniaxially-oriented crystalline polymer thin film of any of Examples 16-18, where the thin film includes a single layer.
Example 20: The uniaxially-oriented crystalline polymer thin film of any of Examples 16-18, where the thin film includes a multilayer.
Example 21: A polymer thin film includes (a) an elastic modulus having a center-to-edge variability of less than approximately 10% or (b) an optical axis having a center-to-edge variability of less than approximately 5°.
Example 22: The polymer thin film of Example 20, where the elastic modulus variability is less than approximately 10% and the optical axis variability is less than approximately 5°.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 2100 in FIG. 21) or that visually immerses a user in an artificial reality (such as, e.g., virtual-reality system 2200 in FIG. 22). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 21, augmented-reality system 2100 may include an eyewear device 2102 with a frame 2110 configured to hold a left display device 2115(A) and a right display device 2115(B) in front of a user's eyes. Display devices 2115(A) and 2115(B) may act together or independently to present an image or series of images to a user. While augmented-reality system 2100 includes two displays, embodiments of this disclosure may be implemented in augmented-reality systems with a single NED or more than two NEDs.

In some embodiments, augmented-reality system 2100 may include one or more sensors, such as sensor 2140. Sensor 2140 may generate measurement signals in response to motion of augmented-reality system 2100 and may be located on substantially any portion of frame 2110. Sensor 2140 may represent one or more of a variety of different sensing mechanisms, such as a position sensor, an inertial measurement unit (IMU), a depth camera assembly, a structured light emitter and/or detector, or any combination thereof. In some embodiments, augmented-reality system 2100 may or may not include sensor 2140 or may include more than one sensor. In embodiments in which sensor 2140 includes an IMU, the IMU may generate calibration data based on measurement signals from sensor 2140. Examples of sensor 2140 may include, without limitation, accelerometers, gyroscopes, magnetometers, other suitable types of sensors that detect motion, sensors used for error correction of the IMU, or some combination thereof.

In some examples, augmented-reality system 2100 may also include a microphone array with a plurality of acoustic transducers 2120(A)-2120(J), referred to collectively as acoustic transducers 2120. Acoustic transducers 2120 may represent transducers that detect air pressure variations induced by sound waves. Each acoustic transducer 2120 may be configured to detect sound and convert the detected sound into an electronic format (e.g., an analog or digital format). The microphone array in FIG. 21 may include, for example, ten acoustic transducers: 2120(A) and 2120(B), which may be designed to be placed inside a corresponding ear of the user, acoustic transducers 2120(C), 2120(D), 2120(E), 2120(F), 2120(G), and 2120(H), which may be positioned at various locations on frame 2110, and/or acoustic transducers 2120(I) and 2120(J), which may be positioned on a corresponding neckband 2105.

In some embodiments, one or more of acoustic transducers 2120(A)-(J) may be used as output transducers (e.g., speakers). For example, acoustic transducers 2120(A) and/or 2120(B) may be earbuds or any other suitable type of headphone or speaker.

The configuration of acoustic transducers 2120 of the microphone array may vary. While augmented-reality system 2100 is shown in FIG. 21 as having ten acoustic transducers 2120, the number of acoustic transducers 2120 may be greater or less than ten. In some embodiments, using higher numbers of acoustic transducers 2120 may increase the amount of audio information collected and/or the sensitivity and accuracy of the audio information. In contrast, using a lower number of acoustic transducers 2120 may decrease the computing power required by an associated controller 2150 to process the collected audio information. In addition, the position of each acoustic transducer 2120 of the microphone array may vary. For example, the position of an acoustic transducer 2120 may include a defined position on the user, a defined coordinate on frame 2110, an orientation associated with each acoustic transducer 2120, or some combination thereof.

Acoustic transducers 2120(A) and 2120(B) may be positioned on different parts of the user's ear, such as behind the pinna, behind the tragus, and/or within the auricle or fossa. Or, there may be additional acoustic transducers 2120 on or surrounding the ear in addition to acoustic transducers 2120 inside the ear canal. Having an acoustic transducer 2120 positioned next to an ear canal of a user may enable the microphone array to collect information on how sounds arrive at the ear canal. By positioning at least two of acoustic transducers 2120 on either side of a user's head (e.g., as binaural microphones), augmented-reality device 2100 may simulate binaural hearing and capture a 3D stereo sound field around about a user's head. In some embodiments, acoustic transducers 2120(A) and 2120(B) may be connected to augmented-reality system 2100 via a wired connection 2130, and in other embodiments acoustic transducers 2120(A) and 2120(B) may be connected to augmented-reality system 2100 via a wireless connection (e.g., a BLUETOOTH connection). In still other embodiments, acoustic transducers 2120(A) and 2120(B) may not be used at all in conjunction with augmented-reality system 2100.

Acoustic transducers 2120 on frame 2110 may be positioned in a variety of different ways, including along the length of the temples, across the bridge, above or below display devices 2115(A) and 2115(B), or some combination thereof. Acoustic transducers 2120 may also be oriented such that the microphone array is able to detect sounds in a wide range of directions surrounding the user wearing the augmented-reality system 2100. In some embodiments, an optimization process may be performed during manufacturing of augmented-reality system 2100 to determine relative positioning of each acoustic transducer 2120 in the microphone array.

In some examples, augmented-reality system 2100 may include or be connected to an external device (e.g., a paired device), such as neckband 2105. Neckband 2105 generally represents any type or form of paired device. Thus, the following discussion of neckband 2105 may also apply to various other paired devices, such as charging cases, smart watches, smart phones, wrist bands, other wearable devices, hand-held controllers, tablet computers, laptop computers, other external compute devices, etc.

As shown, neckband 2105 may be coupled to eyewear device 2102 via one or more connectors. The connectors may be wired or wireless and may include electrical and/or non-electrical (e.g., structural) components. In some cases, eyewear device 2102 and neckband 2105 may operate independently without any wired or wireless connection between them. While FIG. 21 illustrates the components of eyewear device 2102 and neckband 2105 in example locations on eyewear device 2102 and neckband 2105, the components may be located elsewhere and/or distributed differently on eyewear device 2102 and/or neckband 2105. In some embodiments, the components of eyewear device 2102 and neckband 2105 may be located on one or more additional peripheral devices paired with eyewear device 2102, neckband 2105, or some combination thereof.

Pairing external devices, such as neckband 2105, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 2100 may be provided by a paired device or shared between a paired device and an eyewear device, thus reducing the weight, heat profile, and form factor of the eyewear device overall while still retaining desired functionality. For example, neckband 2105 may allow components that would otherwise be included on an eyewear device to be included in neckband 2105 since users may tolerate a heavier weight load on their shoulders than they would tolerate on their heads. Neckband 2105 may also have a larger surface area over which to diffuse and disperse heat to the ambient environment. Thus, neckband 2105 may allow for greater battery and computation capacity than might otherwise have been possible on a stand-alone eyewear device. Since weight carried in neckband 2105 may be less invasive to a user than weight carried in eyewear device 2102, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 2105 may be communicatively coupled with eyewear device 2102 and/or to other devices. These other devices may provide certain functions (e.g., tracking, localizing, depth mapping, processing, storage, etc.) to augmented-reality system 2100. In the embodiment of FIG. 21, neckband 2105 may include two acoustic transducers (e.g., 2120(I) and 2120(J)) that are part of the microphone array (or potentially form their own microphone subarray). Neckband 2105 may also include a controller 2125 and a power source 2135.

Acoustic transducers 2120(I) and 2120(J) of neckband 2105 may be configured to detect sound and convert the detected sound into an electronic format (analog or digital). In the embodiment of FIG. 21, acoustic transducers 2120(I) and 2120(J) may be positioned on neckband 2105, thereby increasing the distance between the neckband acoustic transducers 2120(I) and 2120(J) and other acoustic transducers 2120 positioned on eyewear device 2102. In some cases, increasing the distance between acoustic transducers 2120 of the microphone array may improve the accuracy of beamforming performed via the microphone array. For example, if a sound is detected by acoustic transducers 2120(C) and 2120(D) and the distance between acoustic transducers 2120(C) and 2120(D) is greater than, e.g., the distance between acoustic transducers 2120(D) and 2120(E), the determined source location of the detected sound may be more accurate than if the sound had been detected by acoustic transducers 2120(D) and 2120(E).

Controller 2125 of neckband 2105 may process information generated by the sensors on neckband 2105 and/or augmented-reality system 2100. For example, controller 2125 may process information from the microphone array that describes sounds detected by the microphone array. For each detected sound, controller 2125 may perform a direction-of-arrival (DOA) estimation to estimate a direction from which the detected sound arrived at the microphone array. As the microphone array detects sounds, controller 2125 may populate an audio data set with the information. In embodiments in which augmented-reality system 2100 includes an inertial measurement unit, controller 2125 may compute all inertial and spatial calculations from the IMU located on eyewear device 2102. A connector may convey information between augmented-reality system 2100 and neckband 2105 and between augmented-reality system 2100 and controller 2125. The information may be in the form of optical data, electrical data, wireless data, or any other transmittable data form. Moving the processing of information generated by augmented-reality system 2100 to neckband 2105 may reduce weight and heat in eyewear device 2102, making it more comfortable to the user.

Power source 2135 in neckband 2105 may provide power to eyewear device 2102 and/or to neckband 2105. Power source 2135 may include, without limitation, lithium ion batteries, lithium-polymer batteries, primary lithium batteries, alkaline batteries, or any other form of power storage. In some cases, power source 2135 may be a wired power source. Including power source 2135 on neckband 2105 instead of on eyewear device 2102 may help better distribute the weight and heat generated by power source 2135.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 2200 in FIG. 22, that mostly or completely covers a user's field of view. Virtual-reality system 2200 may include a front rigid body 2202 and a band 2204 shaped to fit around a user's head. Virtual-reality system 2200 may also include output audio transducers 2206(A) and 2206(B). Furthermore, while not shown in FIG. 22, front rigid body 2202 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 2100 and/or virtual-reality system 2200 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 2100 and/or virtual-reality system 2200 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 2100 and/or virtual-reality system 2200 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a polymer thin film that comprises or includes polyvinylidene fluoride include embodiments where a polymer thin film consists essentially of polyvinylidene fluoride and embodiments where a polymer thin film consists of polyvinylidene fluoride.

What is claimed is:

1. A method comprising:
heating a segment of a crystallizable polymer article to a first temperature;
applying a stress to the crystallizable polymer article in an amount effective to induce a positive strain within the heated segment of the crystallizable polymer article; and
heating the segment of the crystallizable polymer article to a second temperature greater than the first temperature while continuing to apply the stress to the crystallizable polymer article to form a uniaxially oriented crystalline polymer article.

2. The method of claim 1, wherein heating the crystallizable polymer article comprises continuously increasing the temperature from the first temperature to the second temperature.

3. The method of claim 1, wherein heating the crystallizable polymer article comprises discontinuously increasing the temperature from the first temperature to the second temperature.

4. The method of claim 1, comprising:
conveying the crystallizable polymer article from a feeder roller across a gap to a take-up roller; and
applying the stress to the heated segment of the crystallizable polymer article within the gap.

5. The method of claim 4, wherein a rate of rotation of the feeder roller is less than a rate of rotation of the take-up roller.

6. The method of claim 4, comprising heating the segment of the crystallizable polymer article within the gap.

7. The method of claim 4, wherein heating the segment of the crystallizable polymer article comprises heating at least one of the feeder roller and the take-up roller.

8. The method of claim 1, comprising:
attaching a clip array to opposing edges of the crystallizable polymer article, the clip array comprising a plurality of first clips slidably disposed on a first track located proximate to a first edge of the crystallizable polymer article and a plurality of second clips slidably disposed on a second track located proximate to a second edge of the crystallizable polymer article;
applying the stress to the crystallizable polymer article along a transverse direction by increasing a distance between the first clips and the second clips; and
decreasing an inter-clip spacing amongst the first clips and amongst the second clips along a machine direction while applying the stress.

9. The method of claim 8, comprising decreasing a strain rate of the crystallizable polymer article along the machine direction while applying the stress.

10. The method of claim 8, wherein the first and second clips are configured to slide along a parabolic path.

11. The method of claim 1, wherein the crystallizable polymer article comprises a thin film or a fiber.

12. The method of claim 1, wherein the crystallizable polymer comprises a fluoropolymer.

13. The method of claim 1, wherein the crystallizable polymer comprises a polymer selected from the group consisting of polyethylene, polyvinylidene fluoride, and a polyester.

14. The method of claim 1, wherein the crystallizable polymer has a molecular weight of at least approximately 100,000 g/mol.

15. The method of claim 1, wherein the uniaxially oriented crystalline polymer article comprises at least one property selected from the group consisting of elastic modulus, yield strength, thermal conductivity, haze, piezoelectric strain coefficient (d₃₁), electromechanical coupling coefficient (k₃₁), refractive index, and birefringence that is improved relative to a crystalline polymer article that is stretched using a constant stretching temperature.

16. A uniaxially-oriented crystalline polymer thin film comprising:
a cross-stretch direction width of at least approximately 0.4 m; and
(a) variability in elastic modulus of less than approximately 10% across the cross-stretch direction width; or
(b) variability in optical axis of less than approximately 5° across the cross-stretch direction width.

17. The uniaxially-oriented crystalline polymer thin film of claim 16, wherein:
(a) variability in the elastic modulus is less than approximately 10% across the cross-stretch direction width; and
(b) variability in the optical axis is less than approximately 5° across the cross-stretch direction width.

18. The uniaxially-oriented crystalline polymer thin film of claim 16, wherein the crystalline polymer comprises a polymer selected from the group consisting of polyethylene, polyvinylidene fluoride, and a polyester.

19. The uniaxially-oriented crystalline polymer thin film of claim 16, wherein the thin film comprises a single layer.

20. A polymer thin film comprising:
(a) an elastic modulus having a center-to-edge variability of less than approximately 10%; or
(b) an optical axis having a center-to-edge variability of less than approximately 5°.
